(19) United States
(12) Patent Application Publication
(10) Pub. No.: US 2016/0205220 A1
(43) Pub. Date: Jul. 14, 2016

(54) INTELLIGENT DEVICE SERVER WITH SENSOR

(71) Applicant: Nanoptix Inc., Dieppe (CA)

(72) Inventors: Daniel Vienneau, Dieppe (CA); Michel Vienneau, Dieppe (CA); Jean-Louis Drapeau, Dieppe (CA)

(21) Appl. No.: 14/991,857

(22) Filed: Jan. 8, 2016

Related U.S. Application Data
(60) Provisional application No. 62/101,876, filed on Jan. 9, 2015.

(51) Int. Cl. H04L 29/06; G07F 17/32

(52) U.S. Cl. CPC H04L 67/42; G07F 17/3225

(57) ABSTRACT

The present disclosure provides for an intelligent device server that is to be used in gaming machines, which is comprised of several ports, including a serial port to connect to a printer to print various promotional materials. The device server also utilized a connection means to connect to a sensor typically fastened to the seat adjacent the gaming machine to detect when a player is present and/or leaves. The device server is also comprised of another port to connect to the gaming machine itself to gather user betting information, and would be comprised of another port to connect to a host and therefore other device servers for updates on information and for easy re-flashing purposes.

### CLAIM OF PRIORITY

The present application for patent claims priority to U.S. Provisional Application No. 62/101,876 entitled “Intelligent Device Server with Sensor” filed Jan. 9, 2015, the entire disclosure of which is hereby expressly incorporated by reference herein.

### BACKGROUND

1. Field

The invention relates to device servers, and more specifically to a device server with a sensor for use with gaming machines.

2. Background

In the casino and gaming industry, when a player approaches a gambling machine in order to begin playing, gaming machines can track the amount of bets and monies received before delivering a payout. Further, casinos are able to track their gaming machines in order to monitor which ones are more popular, performing better, and other tracking and data analysis purposes.

However, there is no intelligent device that exists which can be retrofitted to existing gaming machines which can determine when a player is present, and electrically connect to the gaming machine in order to monitor the player's specific gambling patterns and print out promotional materials based on this data. Indeed, a device server is required, connected to a sensor to determine different player presence, which can monitor said player, and based on predetermined conditions which have been programmed into the device server, send instructions to the local printer of the gaming machine in order to print promotional materials or coupons for prizes. It is desirable for such a system to be independent from the much larger casino system, as any device connected thereto is subject to additional regulation and thus requires regulatory approvals. The present device server is independent from such a system, but can connect to an independent host, which includes other device servers on the same network, to send and receive instructions based on which parameters are required to print materials.

The connectability of the device server to the printer and a bill validator of the gamine machine also allows for the gathering of important metrics of these devices, and can re-flash these peripherals or send them instructions if they are down.

### SUMMARY

In one aspect, the present disclosure provides an intelligent device server for use with gaming machines, comprising: a first port electrically connected to the gaming machine to receive data relating to a user interaction with the gaming machine; a second port electrically connected to a printer of the gaming machine to send instructions to print promotional materials based on the user interaction; a third port electrically connected to a host to send and receive data relating to the user interaction with the gaming machine; and, a connection means connected to a sensor to monitor whether the user is present at the gaming machine; wherein the intelligent device server is positioned within the gaming machine and operates independently to existing casino systems.

In another aspect, the present disclosure provides a method for printing promotional materials based on a user interaction with a gambling machine, the steps comprised of: monitoring whether the user is present at the gaming machine; collecting data relating to the user interaction with the gambling machine from a first port; analyzing the data relating to the user interaction with the gambling machine; and, sending instructions to a printer of the gaming machine through a second port to print the promotional materials based on the analysis.

### BRIEF DESCRIPTION OF THE DRAWINGS

The following figures serve to illustrate various embodiments of features of the disclosure. These figures are illustrative and are not intended to be limiting.

FIG. 1 is a schematic view of an intelligent device server connected to a various peripherals and a sensor, according to a first embodiment of the present disclosure.

FIG. 2 is a flowchart diagram of an intelligent device server, according to a first embodiment of the present disclosure.

### DETAILED DESCRIPTION

The following embodiments are merely illustrative and are not intended to be limiting. It will be appreciated that various modifications and/or alterations to the embodiments described herein may be made without departing from the disclosure and any modifications and/or alterations are within the scope of the contemplated disclosure.

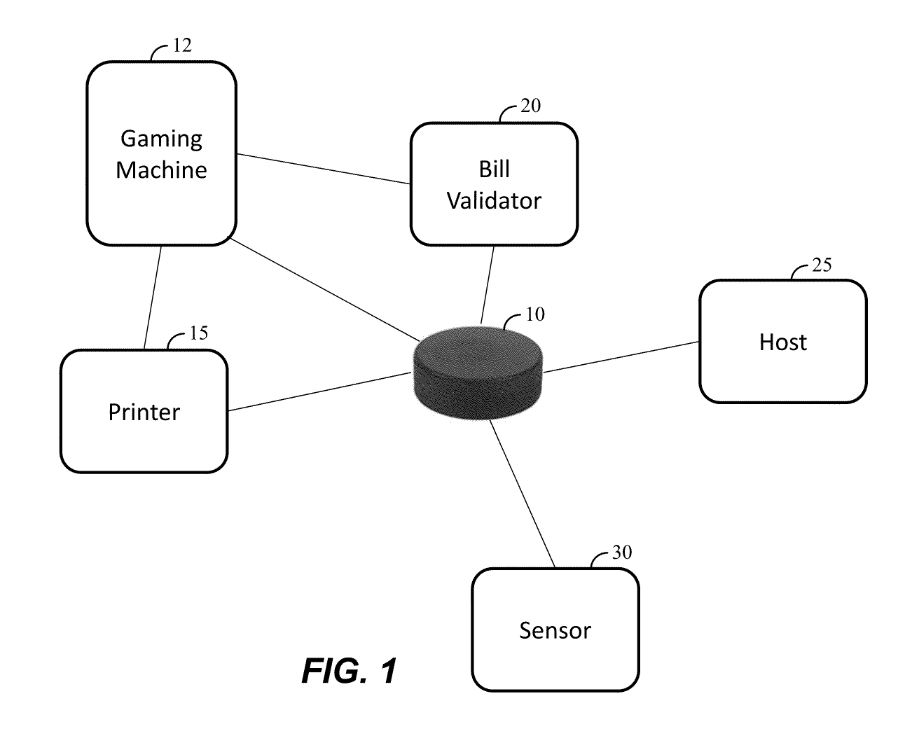

With reference to FIG. 1 and according to a first embodiment of the present device, an intelligent device server 10 is shown connected to various peripherals and a host 25. The purpose of the device server 10 is to provide a device with communications means to be fitted inside existing gaming machines 12 to monitor the progress of a user or player and also detect if said user or player is present. The device server 10 will be completely independent from existing casino systems for several reasons. First, the device server 10 should avoid modifying existing casino systems, as this approach is costly, time consuming, and incorporating the device server 10 into an existing casino system requires additional approvals from gaming labs. Second, the device server 10 is to be a prize-only system, insofar as said device server 10 will not be able to issue playable monies, which would involve a different set of rules and regulations for approvals. The device server 10 is comprised of a second port to electrically connect to the secondary printer port of a printer 15, allowing the printing of various coupons and promotional materials. A worker skilled in the art would appreciate that the second port is typically a serial port and that this is a two-way connection. The device server 10 sends instructions to the printer 15 depending on the playing and gambling history of the player playing on the gaming machine 12, such that if the player has suffered a loss at said gaming machine 12, the device server 10 would receive information related to this loss, analyze this information, and send instructions to the printer 15 to print a coupon or a special prize to be redeemed later. As explained, the device server 10 will be usually positioned within and electrically connected to the gaming machine 12 by means of a first port. A worker skilled in the art would appreciate that the first port would typically be a Serial Attached SCSI (SAS) port. The device server 10 will listen to the gamine machine 12 through the SAS port which provides one-way communication, and obtain information such as: anytime money is inserted, whether by cash of with a ticket or the like; when a player presses on the BET or SPIN button as commonly found on gaming machines 12; or when a player cashes out the remaining balance, if any. A worker skilled in the art would appreciate that this various information can be termed data relating to “user interaction with the gambling machine”. Depending on the information received, the device server 10 can send instructions as aforementioned to the printer 15 to print coupons. The device server 10 is further comprised of a validator serial port to connect to a bill validator 20 through a second port of the bill validator 20 which will typically be an RS232 port, although a worker skilled in the relevant art would appreciate that the bill validator could also be a coin acceptor, mag stripe card reader, smart card reader, etc without departing from the scope of the bill validator definition. The purpose of the two-way connection between the device server 10 and the bill validator 20 is to allow the device server 10 to have direct access to additional information such as important metrics of the bill validator 20. If the bill validator needs to be re-flashed for a certain reason, for instance if a new type of currency is introduced, when bug fixes are necessary or when false currency is provided, the device server 10 can provide the instructions to do so. In the circumstances of the bill validator 20 requiring a re-flash, it is understood that the device server 10 would need to be re-flashed as well. As the device server 10 runs on a simple open-source operating system such as Linux and is connected to a standard Ethernet networking, the device server 10 is very easy to maintain, manage and can be re-flashed easily. This process is simple, efficient and the binary image required can be sent to only certain device servers 10 in an overall system, or all of them at once through their Ethernet connections, at a time convenient for the casino or gaming machine owner, such as off-peak or closed hours. A worker skilled in the relevant art would appreciate that this same flashing capability of the device server 10 can be utilized if the printer 15 also needs to be re-flashed, depending on the specific circumstances. The device server 10 is further comprised of a third port to connect to the host 25, typically by means of an Ethernet cable. A worker skilled in the art would appreciate that the third port will typically be an Ethernet port. The host 25 will often be a computer which is responsible for monitoring the activities of the device server 10 for logging purposes, and will be responsible for managing the marketing campaigns, designing new coupons, enabling/disabling marketing campaigns, programing triggers for different coupons, etc, which can then be sent as information from said host 25 to the device server 10. Finally, the device server 10 is comprised of a wired or wireless connection means to connect to a sensor 30. The sensor 30 is usually a proximity sensor 30 which will detect whether a player is present near the gaming machine 12. Indeed, the purpose of the sensor 30 is to determine when the player leaves the gaming machine 12, which is not a feature presently conceived in existing SAS protocol in current gaming machines 12. In a typical embodiment, the sensor 30 would be hidden in a chair adjacent to the gaming machine, such that the weight of the player will be monitored by the sensor 30. If the player suddenly gets up and leaves the chair and thus the gaming machine 12, the sensor 30 would send a signal to the device server 10 which may or may not send a command to the printer 15 to print a promotional item or coupon. In another embodiment, the sensor 30 will be physically connected to the gaming machine 12 and will monitor the physical presence of the player sitting directly in front of said sensor 30 by means of infrared signal. The device server 10 is further comprised of a host USB port and a slave USB port which can provide added functionality at a later date, and a real-time clock (RTC) with battery. The RTC will be useful in order for the device server 10 to make decisions based on the calendar year, for example providing a different type of coupon on a certain day or time of the year. A person skilled in the relevant art would appreciate that the device server 10 could be comprised of other ports such as an HDMI port for video output to the gaming machine 12. The device server 10 is also designed to be IPv6 addressable in order to accommodate the new standard, and is comprised of a built-in interface bus to allow for the future possible connection of daughter boards that are already designed and available on the market.

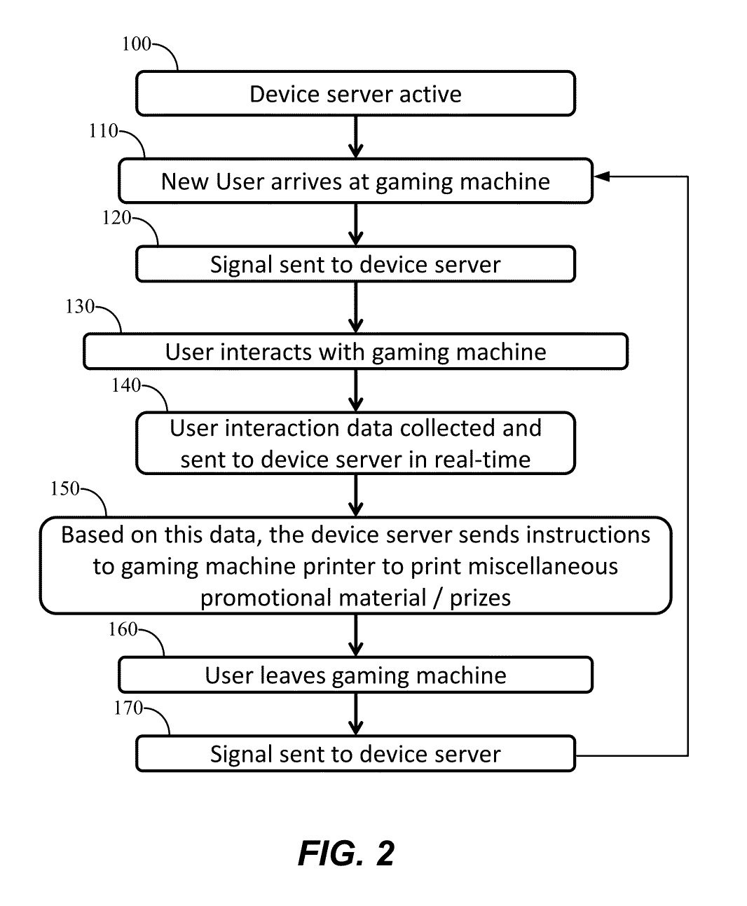

With reference to FIG. 2, a flowchart diagram of the intelligent device server (not shown) is shown. Once the device server is active in step 100, a new user arrives at the gaming machine at step 110. During this time, the device server is monitoring whether said user is present at the gaming machine, such that when such user arrives, a signal is sent to the device server at step 120. In this embodiment, a sensor is utilized, preferably under the chair of the gaming machine such that weight detection is provided and sends the required signal to the device server. Once the user begins interacting with the gaming machine at step 130, this data is collected and sent from the gaming machine to the device server at step 140 which is electrically connected thereto by a first port of the device server. The device server analyzes this data and based on parameters chosen by the casino, sends instructions to the printer (not shown) to print promotional materials and prizes through a second port, at step 150. Once the user leaves the machine at step 160, a signal is sent to the device server at step 170, and a new user arriving at the machine reinitializes the process at step 110.

Many modifications of the embodiments described herein as well as other embodiments may be evident to a person skilled in the art having the benefit of the teachings presented in the foregoing description and associated drawings. It is understood that these modifications and additional embodiments are captured within the scope of the contemplated invention which is not to be limited to the specific embodiment disclosed.

What is claimed is:

1. An intelligent device server for use with gaming machines, comprising:
a first port electrically connected to the gaming machine to receive data relating to a user interaction with the gaming machine;
a second port electrically connected to a printer of the gaming machine to send instructions to print promotional materials based on the user interaction;
a third port electrically connected to a host to send and receive data relating to the user interaction with the gaming machine; and,
a connection means connected to a sensor to monitor whether the user is present at the gaming machine;
wherein the intelligent device server is positioned within the gaming machine and operates independently to existing casino systems.

2. The intelligent device server of claim 1, further comprised of a validator serial port electrically connected to a bill validator of the gaming machine to re-flash the bill validator and to determine whether the bill validator is functional.

3. The intelligent device server of claim 1, wherein the third port is an Ethernet port.

4. The intelligent device server of claim 1, wherein the connection means is wired.

5. The intelligent device server of claim 1, wherein the connection means is wireless.

6. A method for printing promotional materials based on a user interaction with a gambling machine, the steps comprised of:
monitoring whether the user is present at the gaming machine;
collecting data relating to the user interaction with the gambling machine from a first port;
analyzing the data relating to the user interaction with the gambling machine; and,
sending instructions to a printer of the gaming machine through a second port to print the promotional materials based on the analysis.

7. The method of claim 6, further comprised of sending the data relating to the user interaction and user presence to a host through a third port;

8. The method of claim 7, further comprised of receiving instructions from the host based on the user interaction data through the third port;

9. The method of claim 6, wherein the instructions received from the host include data relative to a bill validator.

10. The method of claim 9, further comprised of sending instructions to a bill validator through a validator serial port.

11. The method of claim 6, wherein a sensor positioned on a chair of the gaming machine is utilized to monitor where the user is present.
